(19) United States
(12) Patent Application Publication
(10) Pub. No.: US 2025/0100579 A1
(43) Pub. Date: Mar. 27, 2025

(54) HIERARCHICAL SYSTEM FOR CONTROLLING AN AUTOMATED VEHICLE

(71) Applicant: Robert Bosch GmbH, Stuttgart (DE)

(72) Inventors: Johannes Christian Mueller, Stuttgart (DE); Martin Stoll, Renningen (DE); Maxim Dolgov, Renningen (DE); Ralf Kohlhaas, Calw (DE); Stefan Ruppin, Grafenau (DE)

(21) Appl. No.: 18/892,609

(22) Filed: Sep. 23, 2024

(30) Foreign Application Priority Data
Sep. 27, 2023 (DE) 10 2023 209 460.6

(51) Int. Cl. B60W 60/00; B60W 50/00

(52) U.S. Cl. CPC B60W 60/001; B60W 50/0098; B60W 2556/40

(57) ABSTRACT

A hierarchical system for controlling an automated vehicle. The system includes: a first hardware-based layer designed to receive a first control signal and to carry out a conversion in terms of control technology of the first received control signal, or another base layer, and: a second reflex-based layer, hierarchically superordinate to the first hardware layer; and/or a third motion-based layer hierarchically superordinate to the second reflex-based layer; and/or a fourth intent-based layer; and/or a fifth context-based layer.

### CROSS REFERENCE

The present application claims the benefit under 35 U.S.C. § 119 of German Patent Application No. DE 10 2023 209 460.6 filed on Sep. 27, 2023, which is expressly incorporated herein by reference in its entirety.

### FIELD

The present invention relates to a hierarchical system for controlling an automated vehicle.

### BACKGROUND INFORMATION

Traditionally, software stacks for automated vehicles are designed according to the sense-plan-act principle: The “sense” component is responsible for constructing a model of the environment from detected sensor data, the “plan” component derives a plan for the automated vehicle based on the generated model and the “act” component translates this into control commands for the vehicle. This principle is not only applied to software stacks that primarily use model-based algorithms, but also to those that are implemented by means of deep learning. An example of such software stacks is described in U.S. Patent Application No. US 2023/202, 489 A1.

One challenge with such a stack structure is to design it robustly, so that it can handle degradation reliably. A well-known approach is to implement two parallel signal processing paths—one that is optimized for performance and one that is designed to ensure safety. However, such a structure can lead to the performance path frequently reaching the limits imposed by the path optimized for safety, causing the overall system to oscillate. As a result, the robustness of such a software stack for an automated vehicle is reduced, which can lead to a reduced control quality of the vehicle.

### SUMMARY

It is an object of the present invention to provide a solution to improve a software stack for automated vehicles.

This object may be achieved by a hierarchical system for controlling an automated vehicle having certain features of the present invention.

According to a first aspect, the present invention relates to a hierarchical system for controlling an automated vehicle. According to an example embodiment of the present invention, the method comprises:
a first hardware-based layer, which is designed to receive a first control signal and to carry out a conversion in terms of control technology of the first received control signal, or another base layer, and:
a second reflex-based layer, which is hierarchically superordinate to the first hardware layer and which is designed to receive a control signal from at least one further superordinate layer and to convert it into the first control signal for the underlying hardware-based layer, wherein the second reflex-based layer is further designed to intervene on the basis of first scene-specific data; and/or
a third motion-based layer, which is hierarchically superordinate to the second reflex-based layer and which is designed to receive a base trajectory from the overlying layer and to convert it into a second control signal for the second reflex-based layer, and wherein the third motion-based layer is further designed to intervene on the basis of the first scene-specific data; and/or
a fourth intent-based layer, which is designed to generate the base trajectory for the third motion-based layer on the basis of the first scene-specific data and to transmit this to the third layer via a third control signal (84); and/or
a fifth context-based layer, which is designed to generate a fourth control signal for the intent-based layer on the basis of second scene-specific data.

A fundamental idea of the present invention is to divide the hierarchical system for automated vehicles, which can be formed as a software stack, into a plurality of layers, each layer of which contains an “environment modeling” component for detecting the environment of the vehicle in the form of a mathematical model based on environment data that is built on sensor-based information, along with a “planning” component for planning a task, such as trajectory planning, for the vehicle. The individual layers of the hierarchical system typically operate at different operating frequencies, wherein more time can be given to the planning of complex tasks, e.g. the handling of interactions with other road users, than to the carrying out of simple tasks, such as, e.g., trajectory control. Alternatively, it would also be possible to operate all or at least some shifts at the same operating frequency. The result of the planning from one layer serves as the specification for the layer directly below. Conversely, a layer can override the specification from the layer directly above it if this conflicts with the result of the planning for this layer.

The proposed layer-based system architecture thus moves away from the single Perceive—Plan—Act pipeline towards a robotic system consisting of different hierarchical layers in each case with one Perceive—Check—Plan pipeline per layer, in order to handle different tasks on different time scales and complexity levels. The upper layer of two successive layers receives information from its lower layer and in return sends a control signal to its lower layer.

The advantages of the hierarchical system or the proposed layered architecture according to the present invention result from the fact that the present AD system is divided into self-contained or independent parts with a clear purpose and interfaces are defined between these parts or layers. In particular, the hierarchical system offers the following advantages:

The layered architecture according to the present invention defines interfaces between the layers, such that the task of implementing the layers can be assigned to different teams. As soon as each team has reached a useful conversion state, even in its simplest form, the entire system can be stacked together for testing and iterative development.

The definition of the interfaces allows the application of familiar concepts from software development. The application of the so-called SOLID principle in particular can help to maintain an overview of the entire software stack, which is often lost without a clear framework structure.

A subsystem from one layer downwards with a simplified upper layer can already bring customer benefits. For example, a lane-keeping system with automated speed control for the highway can be realized with an interaction layer that provides the driving corridor, built up from the detected lanes, while the motion and the reflex layer remain unaffected.

It is often easier to define system KPIs than to find meaningful component KPIs, e.g., for recognition or prediction. Due to a multi-layer architecture, KPIs can be created for each layer or subsets of layers and these can be optimized separately or in a layer-specific manner. As a result, the use of complex system KPIs that would be used in an unstructured architecture is avoided.

A further advantage of the hierarchical layered architecture according to the present invention is that each layer can be tested and compared in the simulation, wherein other layers are simulated. In this way, suitable and application-specific requirements can be placed on the simulation. For example, the simulation of the reflex layer will focus on vehicle driving dynamics but disregard visibility, while the interaction layer will focus on meaningful models for traffic behavior and visibility, but simplify driving dynamics for the simulation.

One possible configuration of the hierarchical system provides that the scene-specific data are generated from at least one of the following sources: sensor-based environment perception of the vehicle, map data, aggregated environment data from a number of different data sources. As a result, the advantage is achieved that the generation of a trajectory for the vehicle is effected efficiently and in a way that is specific to the environment.

One possible configuration of the hierarchical system provides that each of the layers, with the exception of the first hardware-based layer, is designed to aggregate and model an environment of the vehicle by means of a modeling module, to examine control signals received from other layers by means of a verification module and in each case to create layer-specific trajectory planning for the vehicle by means of a planning module, which trajectory planning can be used as a specification for a layer arranged directly below it. As a result, the advantage is achieved that each layer can act independently of the other layers within the hierarchical system, which in particular allows efficient task distribution and task processing with varying degrees of complexity.

One possible configuration of the hierarchical system provides that a layer, which is directly subordinate to another layer, is designed to overwrite the control signal received and serving as a specification from the layer directly above it, if this received control signal is in conflict with layer-specific trajectory planning. As a result, an efficient cross-layer or layer-specific safety mechanism is implemented, which increases the safety of the vehicle to be controlled.

One possible configuration of the hierarchical system provides that the first hardware-based layer is designed to process sensor-specific data of the vehicle by means of a sensor module and to provide these to layers arranged above it, to examine received sensor signals from layers above it by means of a check module, and furthermore to directly access a control system of the vehicle, in order to execute a trajectory planning transmitted to it by the second reflex-based layer directly above it by means of an execution module. As a result, the advantage is obtained that the vehicle can be controlled efficiently.

One possible configuration of the hierarchical system provides that the second reflex-based layer is designed to determine, on the basis of a localization unit, a deviation between trajectory planning transmitted by the third motion-based layer arranged directly above it and its layer-specific trajectory planning. As a result, the advantage is obtained that potential errors can be recognized and corrected during trajectory planning before they can influence the control system of the vehicle.

One possible configuration of the hierarchical system provides that the third motion-based layer is designed to create a trajectory planning for the second reflex-based layer arranged directly below it on the basis of an environment model implemented in the second reflex-based layer, wherein the trajectory planning of the third layer provides for planning alternative trajectories for the vehicle, which take into account safety-relevant, vehicle-relevant and/or environment-relevant parameters. As a result, the advantage is obtained that complex trajectory planning can be carried out efficiently and at the same time the safety of the vehicle is taken into account accordingly.

One possible configuration of the hierarchical system is that the fourth intent-based layer is designed to undertake trajectory planning on the basis of the first scene-specific data, which takes into account the interaction of the vehicle with its environment. As a result, the advantage is obtained that efficient and more complex trajectory planning is possible.

One possible configuration of the hierarchical system provides that the second scene-specific data of the fifth context-based layer includes data of a driving situation of the vehicle, which extends over a longer planning horizon than a planning horizon for generating the first scene-specific data. As a result, the advantage is obtained that more complex trajectory planning is allowed, with which the control system of the vehicle can be optimized for the respective vehicle environment.

One possible configuration of the hierarchical system provides that the respective safety requirements of the individual layers decrease as the layer hierarchy increases. As a result, the advantage is obtained that safety-relevant aspects can be implemented in layers of the hierarchical system depending on layer-specific requirements and, optionally, with different levels of maturity, which makes the software conversion of the layered architecture of the hierarchical system more efficient overall.

According to a second aspect, the present invention relates to a computer program containing machine-readable instructions which, when executed on one or more computers and/or compute instances, cause the computer(s) or computer instance(s) to perform the method according to the present invention.

According to a third aspect, the present invention relates to a machine-readable data carrier and/or download product comprising the computer program of the present invention.

According to a fourth aspect, the present invention relates to one or more computers and/or compute instances with the computer program and/or with the machine-readable data carrier and/or the download product according to the present invention.

Further measures improving the present invention are explained in more detail below, together with the description of the preferred exemplary embodiments of the present invention, with reference to the figure.

### BRIEF DESCRIPTION OF THE DRAWINGS

FIG. 1 is a schematic representation of a hierarchical system according to an example embodiment of the present invention.

### DETAILED DESCRIPTION OF EXAMPLE EMBODIMENTS

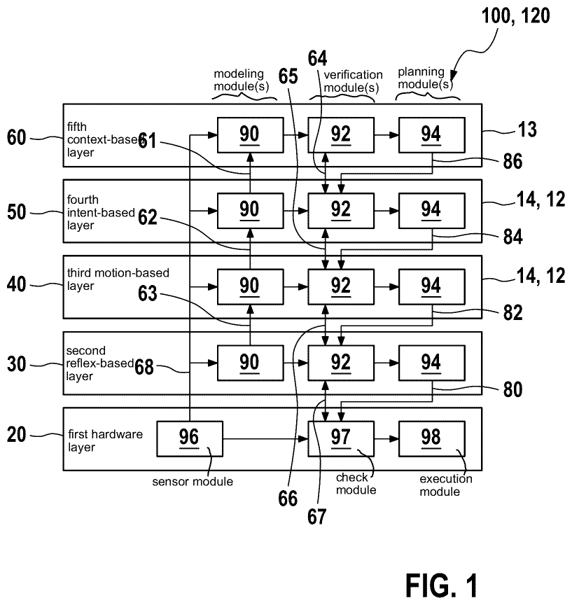

FIG. 1 shows a schematic representation of a hierarchical system 100 for a vehicle or object 120, which can be automated or provide autonomous functions, according to one embodiment of the present invention.

The vehicle 120 can also be generally designed as a mobile object, which implements an assistance function, a mobile agent, a delivery/agricultural robot, to name just a few possible application examples.

In the embodiment of FIG. 1, corresponding unidirectional and/or bidirectional signal connections 61, 62, 63, 64, 65, 66, 67, 68 between the individual blocks 90, 92, 96, 97 of the individual layers of the system 100 are further shown, which in each case schematically represent the individual possible, but not limited, signal flows between the individual layers of the system 100. The signal connections in the horizontal direction between individual blocks 90-92-94 within the layers 30, 40, 50, 60 or, within the hardware layer 20, the signal connections 96-97-98 are shown in FIG. 1 without additional reference signs for the sake of clarity.

In the exemplary embodiment of FIG. 1, the hierarchical system 100 for controlling an automated vehicle 120 comprises the following layers.

The hierarchical system 100 comprises a first hardware-based or hardware layer 20, which is designed to receive a first control signal 80 and to carry out a conversion in terms of control technology of the first received control signal 80.

The hierarchical system 100 comprises a second reflex-based layer 30, which is hierarchically superordinate to the first hardware layer 20 and which is designed to receive a control signal 82 (with base trajectory 14), 84, 86, 88 from at least one further superordinate layer 40, 50, 60 and to convert it into the first control signal 80 for the underlying hardware-based layer 20, wherein the second reflex-based layer 30 is further designed to intervene on the basis of first scene-specific data 12.

The hierarchical system 100 comprises a third motion-based layer 40, which is hierarchically superordinate to the second reflex-based layer 30 and which is designed to receive a base trajectory 14 from the overlying layer 50 and to convert it into a corresponding second control signal 82 for the second reflex-based layer 30, and wherein the third motion-based layer 40 is further designed to intervene on the basis of the first scene-specific data 12. The base trajectory 14 is to be understood as a first or fundamental trajectory, which forms the starting point or starting basis for the further trajectories to be developed and represents a kind of basic framework or basic structure for a trajectory to be refined or further developed.

The hierarchical system 100 comprises a fourth intent-based layer 50, which is designed to generate the base trajectory 14 for the third motion-based layer 40 on the basis of the first scene-specific data 12 and to transmit this to the third layer 40 via a corresponding third control signal 84.

The hierarchical system 100 comprises a fifth context-based layer 60, which is designed to generate a corresponding fourth control signal 86 for the intent-based layer 50 on the basis of second scene-specific data 13.

The hierarchical system or layered architecture 100 in the embodiment shown in FIG. 1 consists of the above-mentioned individual layers 20, 30, 40, 50, 60, which are connected to each other by signaling technology.

Alternatively or optionally, however, the layered architecture 100 can also comprise fewer than these five individual layers or alternatively consist of more than these five layers. For example, it is possible that the hierarchical system 100 only comprises a so-called base layer, such as the hardware-based layer 20, and that the reflex-based layer 30 is also placed on top. The reflex-based layer 30 can optionally also be counted as one of the base layers of the system 100. Alternatively, the layered architecture 100 can comprise at least one of the other layers 40, 50, 60 in addition to the hardware-based layer 20. In this way, the hierarchical system 100 is flexibly configurable and can have different combinations of layers 30, 40, 50, 60, which are placed on the hardware-based layer 20, depending on the application.

Within each successive pair of layers, the upper layer receives information from its lowest layer and in return sends a control signal to the lower layer.

Optionally, the first and second scene-specific data 12, 13 can be generated from at least one of the following sources: sensor-based environment perception of the vehicle 120, map data, aggregated environment data from a number of different data sources, which can be implemented in-vehicle or external to the vehicle.

Optionally, each of the individual layers 30, 40, 50, 60, with the exception of the first hardware-based layer 20, is designed to aggregate and model an environment of the vehicle 120 by means of a modeling module 90 (=perception), to examine control signals received from other layers by means of a verification module 92 (=check) and in each case to create layer-specific trajectory planning for the vehicle 120 by means of a planning module 94 (=plan), which trajectory planning can be used as a specification for a layer arranged directly below it. In this way, the Perceive—Check—Plan pipeline is mapped per layer in the hierarchical system 100. It should be mentioned here that even if, according to FIG. 1, each of the layers 30, 40, 50, 60 comprises the modules 90, 92, 94 of the same name, it is clear to the person skilled in the art that the underlying functionalities behind each of these modules 90, 92, 94 are in each case formed in a layer-specific manner.

The first hardware layer 20 is a special feature in this framework, since it does not carry out any planning for an underlying layer, but accesses the vehicle control system directly via the so-called execution module 98. The hardware layer 20 is nevertheless a part of the proposed layered architecture 100, since its sensory component is accessible to all other layers of the hierarchical system. The hardware layer includes, for example, sensor and actuator drivers, hardware status checks, synchronization of sensors and actuators that operate at the same frequency, sensor calibration and low-level controllers.

The first hardware layer 20 differs from the layers above it as shown in FIG. 1 as follows and comprises the following modules: sensor module 96, check module 97 and execution or conversion module 98.

The sensor module 96 processes sensor-specific data of the vehicle 120 and makes it available to the individual layers 30, 40, 50, 60 arranged above it as required. Furthermore, the sensor module 96 can also detect an environment of the vehicle 120.

By means of the check module 97, received sensor signals, which can also represent environment model data, of the layers 20, 30, 40, 50 above it are examined before they are transmitted to the control system of the vehicle 120 by means of the execution module 98. In this way, trajectory planning transmitted from the second reflex layer 30 directly above to the hardware layer 20 is executed or the corresponding control signals for executing the transmitted trajectory planning are generated. Here, corresponding control signals can be control commands, such as orientation change and acceleration.

Furthermore, the system 100 has the capability that a layer 30, 40, 50, which is directly subordinate to another layer 40, 50, 60, is designed to overwrite the control signal received and serving as a specification from the layer directly superordinate to it, if this received control signal conflicts with layer-specific trajectory planning. It should be added that not every layer of the system 100 necessarily generates trajectories.

Further aspects of the hierarchical system 100 in general and the individual layers of the hierarchical system 100 in particular are specified below, in order to deepen the understanding of the layer-based system.

The motivation for the layer-based system architecture shown in FIG. 1 arises from the idea of how an automated vehicle or object should be structured. This initially provides for the implementation of a hardware layer platform that can control a received trajectory and, optionally, interrupt it in order to prevent a collision. Subsequently, the implementation of a layer that constructs a drivable path for the vehicle from a superordinate ego plan, which is calculated by the next higher layer, is effected. Finally, a layer that takes over the mission for the automated vehicle, e.g. defining the route or pick-up locations, would be added. In this way, one layer reduces the action space of the layer below it. In this way, the lower layers become more general.

The multi-layered system architecture makes it possible to assign the developed software components to one of the layers. This helps to specify requirements and restrictions for the respective software component. In general, the proposed system architecture represents a design methodology and not an implementation concept. The layer view helps in the grouping of modules based on their task, their abstraction level and their system properties. This also adds the possibility of higher runtime frequencies in lower layers and slower, more complex calculations in the upper layers. In addition, this view of the overall system directly shows which modules should be evaluated together and in which hierarchy the software stack itself can be evaluated iteratively. For example, it is possible that each lower layer runs at ten times the frequency of its upper layer, starting at 100 Hz in the reflex layer.

Optionally, the individual views are designed in such a way that the respective safety requirements of the individual layers 20, 30, 40, 50, 60 decrease as the layer hierarchy increases.

Another important aspect of the proposed hierarchical system 100 is that safety is anchored in each layer with responsibilities that correspond to the focus of the respective layer. In this way, the requirements for the safety components vary between the layers with strong argumentation to the lower levels.

In the proposed layered architecture of the system 100, the safety-relevant aspect of autonomous driving with the requirements of ISO 21448 is addressed by the Perceive—Check—Plan structure and the increase in complexity in each layer. The lower the layer, the lower the complexity. Thus, in the proposed layered architecture of the system 100, the lower layers carry the safety load, while the safety load decreases steadily from the hardware layer 20 to the context layer 60. In contrast, performance increases steadily from hardware layer 20 to context layer 60.

In order to carry the safety load, the check component, which checks the input from its upper layer for validity, is of great importance. Since it is usually much more difficult to find a solution than to examine its correctness, the checking mechanism can be integrated into the lower layer.

For example, in an area of pedestrians and cars, it is much more difficult to plan a comfortable and fuel-efficient trajectory than to examine whether the input trajectory provided is safe. In addition, the safety of such a check mechanism can be examined more easily than the generation of the respective trajectory.

If a lower layer recognizes an invalid input, it discards the input and calculates a fallback solution. By default, the fallback solution must be calculated in a less complex way, and therefore performance is traded for robustness in such edge cases. However, safety is maintained in all situations. For the above example, the vehicle would resort to a braking maneuver if a collision with an occupied grid on the entry path from the motion layer 40 is recognized in the control module of the reflex layer 30. This safety strategy is known as top-down safety.

Special aspects of the individual layers 30, 40, 50 and 60 of the hierarchical system 100 are listed below.

### 1) Reflex Layer

In order to specify this layer, it is assumed for the sake of simplicity that it receives a trajectory from its upper layer directly above it and drives it until it receives a new trajectory. Without losing general applicability, it can be assumed that this layer runs at a frequency that is greater than or equal to its input layer, which provides the trajectory for the controller.

In order to bridge the gap until a new trajectory is received, the reflex layer requires a so-called localization unit, so that it can track possible errors between its motion and the motion requested by the trajectory.

For example, a simple frame-to-frame odometry can be sufficient for this purpose, even without registration to the environment. This error is the input to a so-called trajectory tracking control, which calculates control commands for the vehicle, such as acceleration and steering angle.

In this sense, the second reflex-based layer 30 is thus designed to determine, on the basis of a localization unit, a deviation between a trajectory planning transmitted by the third motion-based layer 40 arranged directly above it and its layer-specific trajectory planning.

In addition to the trajectory driver, a safety concept can be implemented in this layer that is state-driven, i.e. a function of the current state and not a prediction. The state-controlled aspect or reflexes give this layer its name. The safety concept for the reflex layer only provides for braking maneuvers at objects or occupancy grids, or in the event that no new trajectory has been received after a certain number of trajectory transmission cycles.

More sophisticated safety functionalities are implemented by higher levels. Due to the high frequency within this reflex layer 30, simple models with short planning horizons (e.g., for constant acceleration) may be sufficient for object tracking, such that perceptual information required for planning is available at the operating frequency.

This is in contrast to more sophisticated behavior priors that can be used in object recognition and tracking in upper layers and reduces the validation effort in the reflex layer. The safety mechanisms in this layer can comprise, e.g., automatic emergency braking. From the perspective of the automotive industry, achieving ASIL-D approval for this layer is a desirable goal, since it has direct access to the vehicle control interfaces

### 2) Motion-Based Layer

This third layer 40 is responsible for generating trajectories for the reflex layer 30, which receives the control command from its upper third layer 40. In this third layer 40, trajectory generation is limited to small-scale planning, e.g. within a travel corridor. Optionally, the upper layer can provide intentions of the ego vehicle and other agents that form the basis for planning in this third layer 40. These intentions can be coded, e.g. as rough trajectories.

Since the motion layer 40 works with rough predictions for the agents, it is also designated as prediction-driven. The aim of this third layer 40 is to solve a convex planning problem, with which the decision for a homotopy class (=behavior mode, such as, e.g., threading in front of or behind another vehicle) was made by the upper layer.

For this purpose, the detections of the sensors are enriched with preliminary information in the form of more sophisticated motion models, such as a single-lane model, which have a longer planning horizon than the models in the reflex layer 30.

In addition, the perception and localization of the motion layer 40 receives perception and localization information from the reflex layer 30, in order to be aware of its environment model and to be able to align the trajectory command in such a way that the reflex layer 30 does not have to compensate for drift between the two localization systems. This is an important prerequisite, since in this way the reflex layer 30 does not have to take into account the localization of the motion layer 40, which operates at a much slower frequency.

It should also be mentioned that the motion layer 40 has its own safety component, the competence of which surpasses the safety component in the reflex layer 30 by allowing it to plan alternative trajectories within the travel corridor horizon, where it can carry out a collision check with the occupancy grids and traffic predictions (which depend on the traffic intentions received from the upper layer). In this way, it can not only brake for an obstacle, but also apply steering and align the course.

More generally formulated, the third motion-based layer 40 is thus designed to create a trajectory planning for the second reflex-based layer 30 arranged directly below it on the basis of an environment model implemented in the second reflex-based layer 30. The trajectory planning of the third layer 40 can provide for planning a number of alternative trajectories for the vehicle 120, which take into account safety-relevant, vehicle-relevant and/or environment-relevant parameters.

With this capability, the motion layer 40 can thus, for example, steer the vehicle 120 to the boundary of the driving corridor and even realize a crash alignment that mitigates the severity of unavoidable crashes, e.g. through an impact to the front of a vehicle instead of into the passenger compartment.

Since the reflex layer 30 with its much shorter preview can intercept plans of the motion layer 40 and thus impair a crash alignment, a so-called overwriting mechanism between the layers is also proposed, which provides that the reflex layer 30 can overwrite control signals from the motion layer 40 if the reflex layer 30 determines a conflict with its own planning.

### 3) Intent-Based Layer

The fourth intent-based layer 50 is designed to undertake trajectory planning on the basis of the first scene-specific data 12, which takes into account an interaction of the vehicle 120 with its environment. Interaction with the environment can involve the other agents.

In other words, this layer 50 thus generates the driving corridor and intentions for the autonomous vehicle 120 and the traffic agents, e.g. in the form of a rough target trajectory for the autonomous vehicle 120 and rough predictions for other road users. The task of intent layer 50 is to handle interaction with traffic and visibility, i.e. it must evaluate how the ego behavior of the vehicle 120 affects traffic and the perception of the AV environment.

Therefore, this layer 50 is interaction-driven. For this purpose, the intent layer 50 must analyze the possible outcomes of the development of the current driving scene and reduce this multimodality to a single targeted future for the motion layer 40 (selection of a homotopy class), so that the intent layer 50 can carry out its small-scale planning.

The intent layer 50 operates at a slower or the same frequency as the motion layer 40. It receives control commands from the context layer 50 directly above it. These commands can be provided, e.g. in the form of a route coded in a destination and a tactical search space and semantic prior knowledge, such as the probability of children stepping carelessly onto the road.

In order to be able to manage interaction, this fourth intent layer 50 requires more sophisticated perception and localization than the motion layer 40. For this purpose, even more sophisticated models for tracking than the motion layer 40 are used and possibly even an intention classification is allowed, which affects not only the motion prediction but also the tracking models.

Since this fourth intent layer 50 is responsible for processing interactions, its planning horizon is in the range of ten seconds. Therefore, the environmental model must be sufficiently consistent for this period of time. For this purpose, the use of semantics and priorities is necessary.

In addition, the perception and localization of the intent layer 50 receives perception and localization information from the motion layer 40, such that it can know the environment model of the lower layer and align the travel corridor and intent commands.

Thus, the safety reasoning for the third intent layer 50 is also based on these components and therefore has significantly weaker requirements than the safety reasoning in the motion layer 40. While a safe maneuver in the motion layer 40 would involve planning within a corridor, the intent layer 50 can plan within a search space that allows it, for example, to continue through a red light to make way for an emergency vehicle.

### 4) Context-Based Layer

The second scene-specific data 13 of the fifth context-based layer 60 optionally includes data of a driving situation of the vehicle 120, which extends over a longer planning horizon than a planning horizon for generating the first scene-specific data 12.

While maintaining the established structure, the context layer 60 provides a control command for the intent layer 50. This command contains a search space for intent layer 50, which is derived from the route and mission of vehicle 120, e.g., driving to destination, finding parking, protecting a person lying on the road from being hit by a following car, along with interaction handling parameters (e.g., different driver models for traffic in different parts of the world) or identifying outliers in traffic behavior, such as drunk drivers or a fight on a sidewalk during which people might run into the road.

The latter two points require observation of the driving situation over a much longer period of time than the period of time observed by the fourth intent layer 50 for its decision-making. In addition, the context layer 60 is responsible for accumulating recurring events in order to build semantic knowledge priorities, such as, e.g., a higher frequency of pedestrians unexpectedly stepping on the road next to a school during a certain time. Therefore, this fifth context layer 60 is designated as the knowledge-driven layer.

Further example embodiments of the present invention are set forth in the numbered examples below:

Example 1. A hierarchical system (100) for controlling an automated vehicle (120), comprising:
a first hardware-based layer (20), which is designed to receive a first control signal (80) and to carry out a conversion in terms of control technology of the first received control signal (80), or another base layer, and:
a second reflex-based layer (30), which is hierarchically superordinate to the first hardware layer (20) and which is designed to receive a control signal (82, 84, 86, 88) from at least one further superordinate layer (40, 50, 60) and to convert it into the first control signal (80) for the underlying hardware-based layer (20), wherein the second reflex-based layer (30) is further designed to intervene on the basis of first scene-specific data (12); and/or
a third motion-based layer (40), which is hierarchically superordinate to the second reflex-based layer (30) and which is designed to receive a base trajectory (14) from the overlying layer (50) and to convert it into a second control signal (82) for the second reflex-based layer (30), and wherein the third motion-based layer (40) is further designed to intervene on the basis of the first scene-specific data (12); and/or
a fourth intent-based layer (50), which is designed to generate the base trajectory (14) for the third motion-based layer (40) on the basis of the first scene-specific data (12) and to transmit this to the third layer (40) via a third control signal (84); and/or
a fifth context-based layer (60), which is designed to generate a fourth control signal (86) for the intent-based layer (50) on the basis of second scene-specific data (13).

Example 2. The hierarchical system (100) according to Example 1, wherein the scene-specific data (12, 13) is generated from at least one of the following sources: sensor-based environment perception of the vehicle (120), map data, aggregated environment data from a number of different data sources.

Example 3. The hierarchical system (100) according to one of the preceding numbered Examples, wherein each of the layers (30, 40, 50, 60), with the exception of the first hardware-based layer (20), is designed to aggregate and model an environment of the vehicle (120) by means of a modeling module (90), to examine control signals received from other layers by means of a verification module (92) and in each case to create layer-specific trajectory planning for the vehicle (120) by means of a planning module (94), which trajectory planning can be used as a specification for a layer arranged directly below it.

Example 4. The hierarchical system (100) according to one of the preceding numbered Examples, wherein a layer (30, 40, 50), which is directly subordinate to another layer (40, 50, 60), is designed to overwrite the control signal received and serving as a specification from the layer directly superordinate to it, if this received control signal is in conflict with layer-specific trajectory planning.

Example 5. The hierarchical system (100) according to one of the preceding numbered Examples, wherein the first hardware-based layer (20) is designed to process sensor-specific data of the vehicle (120) by means of a sensor module (96) and to provide these to layers (30, 40, 50, 60) arranged above it, to examine sensor signals received from layers (20, 30, 40, 50) located above it by means of a check module (97), and furthermore to directly access a control system of the vehicle (120), in order to execute a trajectory planning transmitted by the second reflex-based layer (30) located directly above it by means of an execution module (98).

Example 6. The hierarchical system (100) according to one of the preceding numbered Examples, wherein the second reflex-based layer (30) is designed to determine, on the basis of a localization unit, a deviation between a trajectory planning transmitted by the third motion-based layer (40) arranged directly above it and its layer-specific trajectory planning.

Example 7. The hierarchical system (100) according to one of the preceding numbered Examples, wherein the third motion-based layer (40) is designed to create a trajectory planning for the second reflex-based layer (30) arranged directly below it on the basis of an environment model implemented in the second reflex-based layer (30), wherein the trajectory planning of the third layer (40) provides for planning alternative trajectories for the vehicle (120), which take into account safety-relevant, vehicle-relevant and/or environment-relevant parameters.

Example 8. The hierarchical system (100) according to one of the preceding numbered Examples, wherein the fourth intent-based layer (50) is designed to undertake trajectory planning on the basis of the first scene-specific data (12), which takes into account an interaction of the vehicle (120) with its environment.

Example 9. The hierarchical system (100) according to one of the preceding numbered Examples, wherein the second scene-specific data (13) of the fifth context-based layer (60) includes data of a driving situation of the vehicle (120), which extends over a longer planning horizon than a planning horizon for generating the first scene-specific data (12).

Example 10. The hierarchical system (100) according to one of the preceding numbered Examples, wherein the respective safety requirements of the individual layers (20, 30, 40, 50, 60) decrease as the layer hierarchy increases.

Example 11. A computer program containing machine-readable instructions that, when executed on one or more computers and/or computer instances, cause the computer(s) or compute instance(s) to carry out the method according to one of Examples 1 to 10.

Example 12. A machine-readable data carrier and/or download product comprising the computer program according to Example 11.

Example 13. One or more computers and/or compute instances with the computer program according to Example 11 and/or with the machine-readable data carrier and/or download product according to Example 12.

What is claimed is:

1. A hierarchical system for controlling an automated vehicle, comprising:
a first hardware-based layer, which is configured to receive a first control signal and to carry out a conversion in terms of control technology of the first received control signal, or another base layer; and
a second reflex-based layer, which is hierarchically superordinate to the first hardware layer and which is configured to receive a control signal from at least one further superordinate layer and to convert the received control signal into the first control signal for the first hardware-based layer, wherein the second reflex-based layer is further configured to intervene based on first scene-specific data.

2. The hierarchical system according to claim 1, further comprising:
a third motion-based layer, which is hierarchically superordinate to the second reflex-based layer and which is configured to receive a base trajectory from an overlying layer and to convert the received based trajectory into a second control signal for the second reflex-based layer, and wherein the third motion-based layer is configured to intervene based on the first scene-specific data.

3. The hierarchical system according to claim 2, further comprising:
a fourth intent-based layer, which is configured to generate the base trajectory for the third motion-based layer based on the first scene-specific data and to transmit the base trajectory to the third motion-based layer via a third control signal.

4. The hierarchical system according to claim 3, further comprising:
a fifth context-based layer, which is configured to generate a fourth control signal for the fourth intent-based layer based on second scene-specific data.

5. The hierarchical system according to claim 4, wherein the first and second scene-specific data is generated from at least one of the following sources: sensor-based environment perception of the vehicle, map data, aggregated environment data from a number of different data sources.

6. The hierarchical system according claim 4, wherein each of the second reflex-based layer, the third motion-based layer, the fourth intent-based layer, and the fifth context-based layer, is configured to aggregate and model an environment of the vehicle using a modeling module, to examine control signals received from other layers using a verification module and in each case to create layer-specific trajectory planning for the vehicle using a planning module, which layer-specific trajectory planning can be used as a specification for a layer arranged directly below it.

7. The hierarchical system according to claim 4, wherein each layer, which is directly subordinate to another layer, is configured to overwrite a control signal received and serving as a specification from the layer directly superordinate to it, when the received control signal is in conflict with layer-specific trajectory planning.

8. The hierarchical system according to claim 4, wherein the first hardware-based layer is configured to process sensor-specific data of the vehicle using a sensor module and to provide the processed sensor specific data to layers arranged above it, to examine sensor signals received from the layers located above it using a check module, and to directly access a control system of the vehicle, in order to execute a trajectory planning transmitted by the second reflex-based layer located directly above it using an execution module.

9. The hierarchical system according to claim 6, wherein the second reflex-based layer is configured to determine, based on a localization unit, a deviation between a trajectory planning transmitted by the third motion-based layer arranged directly above it and the layer-specific trajectory planning of the second reflex-based layer.

10. The hierarchical system according to claim 2, wherein the third motion-based layer is configured to create a trajectory planning for the second reflex-based layer arranged directly below it based on an environment model implemented in the second reflex-based layer, wherein the trajectory planning of the third layer provides for planning alternative trajectories for the vehicle), which take into account: (i) safety-relevant parameters and/or (ii) vehicle-relevant parameters and/or (iii) environment-relevant parameters.

11. The hierarchical system according to claim 3, wherein the fourth intent-based layer is configured to undertake trajectory planning based on the first scene-specific data, which takes into account an interaction of the vehicle with an environment of the vehicle.

12. The hierarchical system according to claim 4, wherein the second scene-specific data of the fifth context-based layer includes data of a driving situation of the vehicle, which extends over a longer planning horizon than a planning horizon for generating the first scene-specific data.

13. The hierarchical system according to claim 4, wherein respective safety requirements of the first hardware-based layer, the second reflex-based layer, the third motion-based layer, the fourth intent-based layer, and the fifth context-based layer decrease as the layer hierarchy increases.

14. A non-transitory machine-readable data carrier on which is stored a computer program when, when executed by one or more computers and/or computer instances, implements:
a hierarchical system for controlling an automated vehicle, including:
a first hardware-based layer, which is configured to receive a first control signal and to carry out a conversion in terms of control technology of the first received control signal, or another base layer, and
a second reflex-based layer, which is hierarchically superordinate to the first hardware layer and which is configured to receive a control signal from at least one further superordinate layer and to convert the received control signal into the first control signal for the first hardware-based layer, wherein the second reflex-based layer is further configured to intervene based on first scene-specific data.

15. One or more computers and/or compute instances equipped with a non-transitory machine-readable data carrier on which is stored a computer program when, when executed the one or more computers and/or computer instances, implements:
a hierarchical system for controlling an automated vehicle, including:
a first hardware-based layer, which is configured to receive a first control signal and to carry out a conversion in terms of control technology of the first received control signal, or another base layer, and
a second reflex-based layer, which is hierarchically superordinate to the first hardware layer and which is configured to receive a control signal from at least one further superordinate layer and to convert the received control signal into the first control signal for the first hardware-based layer, wherein the second reflex-based layer is further configured to intervene based on first scene-specific data.
